(19) United States
(12) Patent Application Publication
(10) Pub. No.: US 2024/0305403 A1
(43) Pub. Date: Sep. 12, 2024

(54) Link Adaptation

(71) Applicant: Nokia Technologies Oy, Espoo (FI)

(72) Inventors: Silvio MANDELLI, Tamm (DE); Andreas WEBER, Lehrensteinsfeld (DE); Paolo BARACCA, Stuttgart (DE); Jafar MOHAMMADI, Stuttgart (DE); Kalle Petteri KELA, Kaarina (FI); Teemu Mikael VEIJALAINEN, Helsinki (FI)

(21) Appl. No.: 18/574,899

(22) PCT Filed: Jun. 30, 2021
(86) PCT No.: PCT/EP2021/068002

§ 371 Date: Dec. 28, 2023

(51) Int. Cl. H04L 1/00

(52) U.S. Cl. CPC H04L 1/0025; H04L 1/0003; H04L 1/0026

(57) ABSTRACT

An apparatus, method and computer program is described including: generating a channel quality metric offset; summing a channel quality metric and the channel quality metric offset to generate an adjusted channel quality metric of a channel of a mobile communication system; setting a modulation and coding scheme for transmitting data over the channel based, at least in part, on the adjusted channel quality metric; obtaining feedback data relating to the success of data transfer over said channel; compiling a loss/reward function based, at least in part, on said feedback data; and updating a model using the loss/reward function, wherein the model is used in the generation of said channel quality metric offset.

### FIELD

The present specification relates to link adaptation in mobile communication systems.

### BACKGROUND

Link adaptation may be used to set a modulation and coding scheme (MCS) for transmitting data over a channel of a mobile communication system. There remains a need for further developments in this field.

### SUMMARY

In a first aspect, this specification describes an apparatus comprising means for performing: generating a channel quality metric offset; summing a channel quality metric and the channel quality metric offset to generate an adjusted channel quality metric of a channel of a mobile communication system; setting a modulation and coding scheme for transmitting data over the channel based, at least in part, on the adjusted channel quality metric; obtaining feedback data relating to the success of data transfer over said channel; compiling a loss/reward function based, at least in part, on said feedback data; and updating a model using the loss/reward function, wherein the model is used in the generation of said channel quality metric offset.

The channel quality metric offset may be based, at least in part, on a target error rate (e.g. BLER) for transmissions using the mobile communication system. The modulation and coding scheme (MCS) for transmitting data over the channel may be based, at least in part, on the target error rate.

The feedback data may include an acknowledgment signal indicative of whether a previous transmission over the channel was successful.

Some example embodiments further comprise means for performing: generating the loss/reward function based on a predicted error rate and the obtained feedback signal.

The means for performing generating said channel quality metric offset comprises means for performing: obtaining an initial offset value and an average offset step size from the model; and increasing or decreasing the channel quality metric offset, depending on the feedback signal, by an amount dependent, at least in part, on the average offset step size.

Some example embodiments further comprise means for performing: generating or updating a computational graph comprising the channel quality metric, the channel quality metric offset, the modulation and coding scheme and the feedback signal, wherein the model is based on said computational graph.

Some example embodiments further comprise means for performing: generating, in response to a change in the channel quality metric, a channel quality metric correction term for smoothing adjustments to the channel quality metric offset when summing the channel quality metric and the channel quality metric offset.

In some example embodiments, the model provides said channel quality metric offset. The feedback signal may, for example, include an indication of whether a transmission of a packet of data (e.g. comprising a PDCP packet) was successful.

Some example embodiments further comprise means for performing: obtaining accumulated physical resource block usage in an attempted delivery of the packet of data; and generating the loss/reward function based, at least in part, on the accumulated physical resource block usage and the indication of whether the delivery of the packet was successful.

The loss/reward function may be based, at least in part, on failed packet indications and/or packet delay budget violations.

The channel quality metric may comprises a SINR signal.

Some example embodiments further comprise means for performing: selecting said modulation and coding scheme based on the adjusted channel quality metric and the target error rate using an inner loop link adaptation algorithm.

The channel quality metric offset may be a user device-specific offset.

Some example embodiments further comprise means for performing: determining whether to trigger training of the model.

Some example embodiments further comprise means for performing: resetting the model on detection of a reset condition.

The means may comprise: at least one processor; and at least one memory including computer program code, the at least one memory and the computer program code configured, with the at least one processor, to cause the performance of the apparatus.

In a second aspect, this specification describes a method comprising: generating a channel quality metric offset; summing a channel quality metric and the channel quality metric offset to generate an adjusted channel quality metric of a channel of a mobile communication system; setting a modulation and coding scheme for transmitting data over the channel based, at least in part, on the adjusted channel quality metric; obtaining feedback data relating to the success of data transfer over said channel; compiling a loss/reward function based, at least in part, on said feedback data; and updating a model using the loss/reward function, wherein the model is used in the generation of said channel quality metric offset.

The method may comprise: generating the loss/reward function based on a predicted error rate and the obtained feedback signal.

Generating the channel quality metric offset may comprises: obtaining an initial offset value and an average offset step size from the model; and increasing or decreasing the channel quality metric offset, depending on the feedback signal, by an amount dependent, at least in part, on the average offset step size.

The method may comprise: generating or updating a computational graph comprising the channel quality metric, the channel quality metric offset, the modulation and coding scheme and the feedback signal, wherein the model is based on said computational graph.

The method may comprise: generating, in response to a change in the channel quality metric, a channel quality metric correction term for smoothing adjustments to the channel quality metric offset when summing the channel quality metric and the channel quality metric offset.

In some example embodiments, the model provides said channel quality metric offset. The feedback signal may, for example, include an indication of whether a transmission of a packet of data (e.g. comprising a PDCP packet) was successful.

The method may comprise: obtaining accumulated physical resource block usage in an attempted delivery of the packet of data; and generating the loss/reward function based, at least in part, on the accumulated physical resource block usage and the indication of whether the delivery of the packet was successful.

The method may comprise: selecting said modulation and coding scheme based on the adjusted channel quality metric and the target error rate using an inner loop link adaptation algorithm.

The method may comprise: determining whether to trigger training of the model.

The method may comprise: resetting the model on detection of a reset condition.

In a third aspect, this specification describes an apparatus configured to perform any (at least) any method as described with reference to the second aspect.

In a fourth aspect, this specification describes computer-readable instructions which, when executed by a computing apparatus, cause the computing apparatus to perform (at least) any method as described with reference to the second aspect.

In a fifth aspect, this specification describes a computer-readable medium (such as a non-transitory computer-readable medium) comprising program instructions stored thereon for performing (at least) any method as described with reference to the second aspect.

In a sixth aspect, this specification describes an apparatus comprising: at least one processor; and at least one memory including computer program code which, when executed by the at least one processor, causes the apparatus to perform (at least) any method as described with reference to the second aspect.

In a seventh aspect, this specification describes a computer program comprising instructions for causing an apparatus to perform at least the following: generating a channel quality metric offset; summing a channel quality metric and the channel quality metric offset to generate an adjusted channel quality metric of a channel of a mobile communication system; setting a modulation and coding scheme for transmitting data over the channel based, at least in part, on the adjusted channel quality metric; obtaining feedback data relating to the success of data transfer over said channel; compiling a loss/reward function based, at least in part, on said feedback data; and updating a model using the loss/reward function, wherein the model is used in the generation of said channel quality metric offset.

In an eighth aspect, this specification describes an apparatus comprising: a processor, a machine learning algorithm or some other means for generating a channel quality metric offset; an adder (or some other means) for summing a channel quality metric and the channel quality metric offset to generate an adjusted channel quality metric of a channel of a mobile communication system; a link adaptation module (or some other means) for setting a modulation and coding scheme for transmitting data over the channel based, at least in part, on the adjusted channel quality metric; a feedback arrangement (or some other means) for obtaining feedback data relating to the success of data transfer over said channel; a reward module (or some other means) compiling a loss/reward function based, at least in part, on said feedback data; and training module (or some other means) for updating a model using the loss/reward function, wherein the model is used in the generation of said channel quality metric offset.

### BRIEF DESCRIPTION OF DRAWINGS

Example embodiments will now be described, by way of non-limiting examples, with reference to the following schematic drawings, in which:

FIG. 1 is a block diagram of an end-to-end communication system in accordance with an example embodiment;

FIGS. 2 and 3 are block diagrams systems in accordance with example embodiments;

FIG. 4 is a plot showing an example use of the system of FIG. 3;

FIG. 5 is a flow chart of an algorithm in accordance with an example embodiments;

FIG. 6 is a block diagram of a system in accordance with an example embodiment;

FIGS. 7 and 8 are flow charts of algorithms in accordance with example embodiments;

FIG. 9 shows an algorithm in accordance with an example embodiment;

FIGS. 10, 11, 12A and 12B are plots showing results of simulations in accordance with example embodiments;

FIG. 13 is a flow chart showing an algorithm in accordance with an example embodiment;

FIG. 14 is a block diagram of a system in accordance with an example embodiment;

FIG. 15 is a flow chart showing an algorithm in accordance with an example embodiment;

FIG. 16 is a signalling diagram in accordance with an example embodiment;

FIGS. 17 to 19 are plots showing results of simulations in accordance with example embodiments;

FIG. 20 is a block diagram of components of a system in accordance with an example embodiment; and

FIG. 21 shows tangible media storing computer-readable code which when run by a computer may perform methods according to example embodiments described above.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

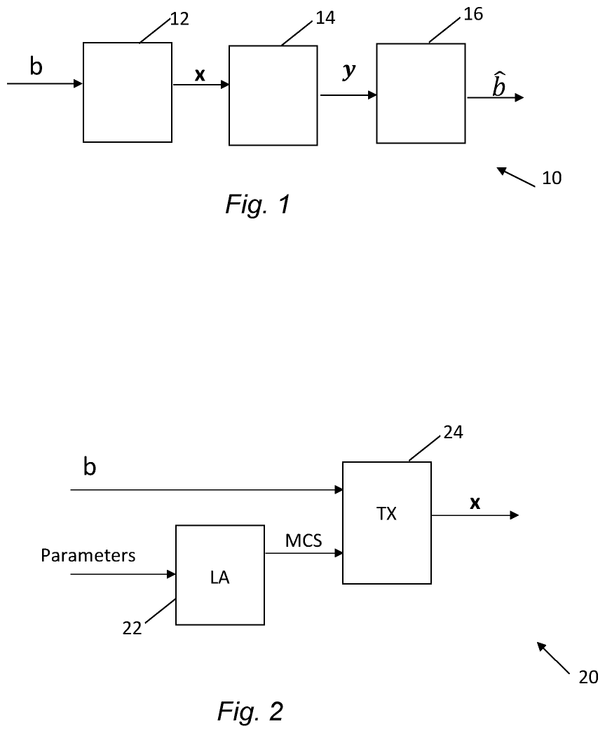

FIG. 1 is a block diagram of an example end-to-end communication system, indicated generally by the reference numeral 10, in accordance with an example embodiment. The system 10 includes a transmitter 12, a channel 14 and a receiver 16. Viewed at a system level, the system 10 converts data (b) received at the input to the transmitter 12 into transmit symbols (x) for transmission over the channel 14 and the receiver 16 generates an estimate of the transmitted data (b) from symbols (y) received from the channel 14.

The transmitter 12 may include a modulator (e.g. using orthogonal frequency division multiplexing (OFDM)) that converts the data symbols (b) into the transmit symbols (x) in accordance with a modulation scheme. The transmit symbols are then transmitted over the channel 14 and received at the receiver 16 as received symbols (y). The receiver may include a demodulator that converts the received symbols (y) into the estimate of the originally transmitted data symbols (b).

FIG. 2 is a block diagram of a transmitter module, indicated generally by the reference numeral 20, in accordance with an example embodiment. The transmitter module 20 may be used to implement the transmitter 12 of the communication system 10 described above.

The transmitter module 20 comprises a link adaptation module 22 and a transmitter 24. The link adaptation module 22 receives a number of parameters and provides a modulation and coding scheme (MCS) for use by the transmitter 24.

The transmitter 24 receives the MCS from the link adaptation module 22 and data symbols (b) for transmission. The transmitter 24 coverts the data symbols (b) into transmit symbols (x) in accordance with the modulation scheme set by the link adaptation module 22.

Link Adaptation (LA) may target arbitrarily low Block Error Rate (BLER). MCS choice may be based, for example, on parameters such as channel quality and error probability expected for each MCS for that channel quality. In this context, traditional schemes for LA may guarantee a target BLER, but often have the drawback of using resources in a non-efficient way.

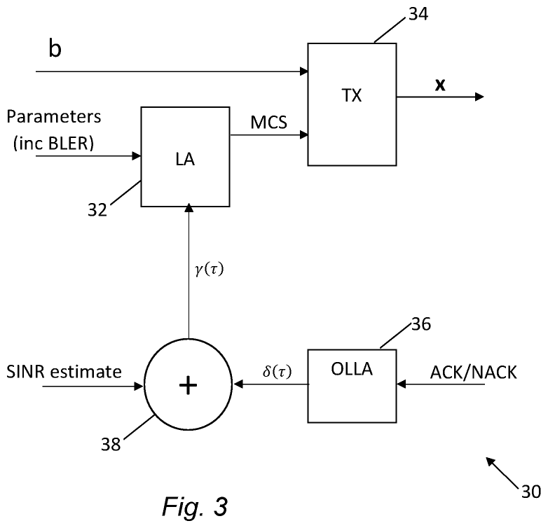

FIG. 3 is a block diagram of a system, indicated generally by the reference numeral 30, in accordance with an example embodiment. The system 30 comprises a link adaptation module 32, a transmitter 34, an outer look link adaptation (OLLA) module 36 and a summing module 38. The link adaptation module 32 and the transmitter 34 are example implementations of the link adaptation module 22 and a transmitter 24 described above. The OLLA 36 and summing module 38 generate a parameter used by the link adaptation module 32.

In the system 30, the link adaptation module 32 receives and generates a highest rate modulation and coding scheme (MCS) that satisfies the target BLER q based on a signal-to-noise-plus-interference ratio (SINR) estimate from the summing module 38. The summing module generates the SINR estimate γ(τ) by correcting the most recent SINR estimate c (e.g. obtained from Channel Quality Indicator (CQI) feedback) using an OLLA offset δ(τ) at time τ, leading to the SINR estimate:

$$γ ( τ ) = c + δ ( τ )$$

The transmitter 34 coverts data symbols (b) into transmit symbols (x) in accordance with the modulation scheme set by the link adaptation module 32.

The OLLA module 36 receives an ACK/NACK message indicating whether the transmission was received. The OLLA offset (sometimes referred to herein as SINR offset), is updated after each first transmission's ACK/NACK is received as follows:

$$δ ( τ ) := δ ( τ ) + Δ \cdot \{ \begin{matrix}\sqrt{\frac{q}{1 - q}} & if ACK is received \\ - \sqrt{\frac{1 - q}{q}} & if NACK is received \\ 0 & if no transmission\end{matrix}$$

Where:
Δ is the OLLA step magnitude; and
the SINR offset is initialized as δ(0):=Δ₀.

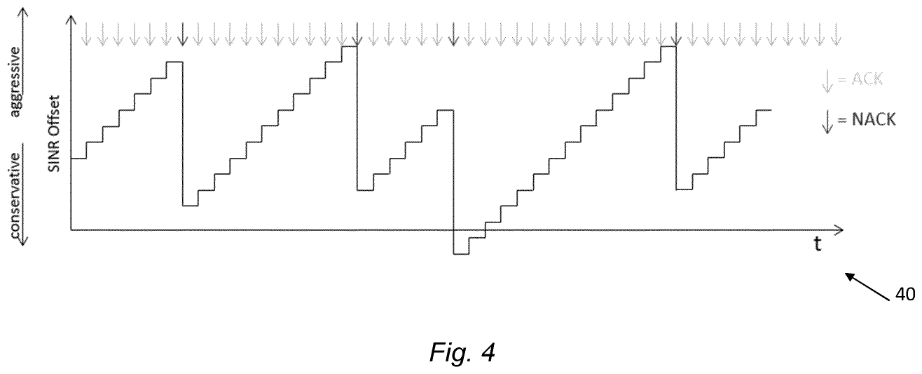

FIG. 4 is a plot, indicated generally by the reference numeral 40, showing an example use of the system of FIG. 3. In the example plot 40, the target BLER q=10%.

In the plot 40, each time an ACK decision is received (indicating the successful transmission of data), the SINR offset δ(τ) is increased by the following multiple of A:

$$\sqrt{\frac{q}{1 - q}} = \sqrt{\frac{0.1}{1 - 0.1}} = \sqrt{\frac{1}{9}} = \frac{1}{3}$$

Each time an NACK decision is received (indicating that the transmission of data was unsuccessful), the SINR offset δ(τ) is decreased by the following multiple of Δ:

$$\sqrt{\frac{1 - q}{q}} = \sqrt{\frac{0.9}{0.1}} = \sqrt{9} = 3$$

In the example plot 40, six ACK signals are received (so that the SINR offset gets increasingly larger) before a single NACK signal is received (that reduces the SINR offset by more than the increase of the six ACK signals). Then, 10 ACK signals are received (increasing the SINR offset to more than the previous high) before the next NACK signal is received. Four ACK signals are then received before the next NACK signal. Then, 13 ACK signals are received before a NACK signal followed by 10 ACK signals are received.

When targeting ultra-reliable low latency (URLCC) communications, due to its definition, OLLA must be properly parametrized to avoid too conservative rate selections (e.g. step size too big) or slow convergence (e.g. step size too small), depending on the scenario.

As discussed in detail below, in a first approach in accordance with the principles described herein, an algorithm is provided that allows adapting the SINR offset parameters, e.g. the OLLA/SINR offset initial value Δ₀ and average step size Δ, during runtime. In this approach, a differentiable computation graph may be built encompassing all transmissions happened during time transmission intervals (TTIs) τ ∈ T, that comprises:
the link adaptation (LA) inputs, e.g. the most recent non-corrected SINR estimate c(τ), the current correction term \hat{δ}(τ) and the desired target BLER q;
the index of the selected MCS m(τ) for the transmission at TTI τ; and
the ACK/NACK e(τ) information about the transmission happened at TTI τ.

This allows the same techniques/libraries used in neural networks to be used to backpropagate the derivatives of a loss function back to the OLLA parameters. One can then optimize OLLA's parameters (e.g. initial value and average step size) at runtime and in each single cell by using known techniques (e.g. Adam gradient descent).

One solution would be to learn a single initial value Δ₀ and single average step size Δ for each cell/base station (or aggregate of them). Extensions to this concept include:
Keeping a table with different OLLA parameter values for each managed target BLER q, and training only with the data generated with transmissions performed with the considered first target BLER. The table could be extended with other dimensions (e.g. in addition to target BLER, consider the load of the system, e.g. short/mid/high load, sector/beam etc.).
Since derivatives with respect of the SINR offset and the OLLA parameters can be computed, one can in principle apply the proposed technique to learn the parameters of a generic differentiable mechanism (e.g. a NN) that determines the SINR offset or the OLLA parameters, based on some other inputs. This could allow to backpropagate information available during runtime to optimize high layer protocols.
Current OLLA mechanisms can be enhanced with the presence of a new parameter called CQI adaptation parameter, whose task is to smooth out the effect of new uncorrected SINR estimates (due to e.g. new CQI report).

As discussed further below, a user device can leverage the proposed procedures to offset their CQI reports with OLLA mechanisms and learn the CQI offset hyper-parameters (e.g. OLLA parameters) with the proposed technique.

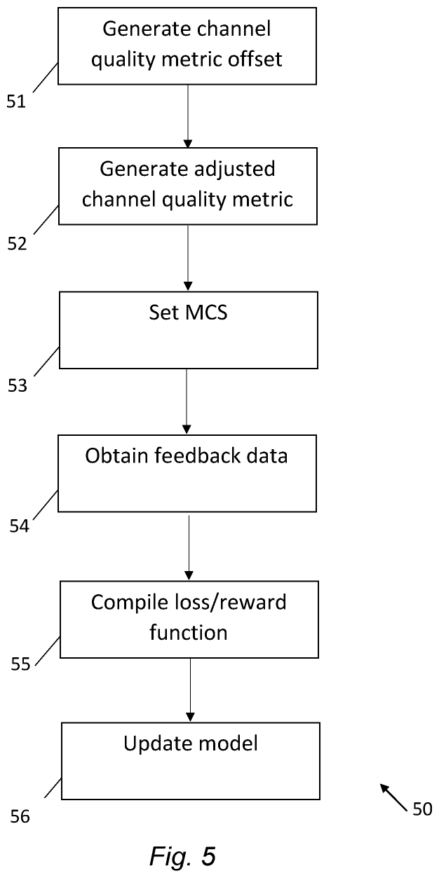

FIG. 5 is a flow chart of an algorithm, indicated generally by the reference numeral 50, in accordance with an example embodiments.

The algorithm 50 starts at operation 51, where a channel quality metric offset δ(τ) is generated.

At operation 52, a channel quality metric, such as SINR, denoted herein by c is summed with the channel quality metric offset generated in the operation 51 in order to generate an adjusted channel quality metric γ(τ) of a channel of a mobile communication system (such that γ(τ)=c+δ(τ)).

A modulation and coding scheme (MCS) is set in operation 53 for use in transmitting data over the channel. The MCS is generated based, at least in part, on the adjusted channel quality metric γ(τ).

At operation 54, feedback data relating to the success of data transfer over said channel are obtained. Such data may be the ACK/NACK signals discussed above.

A loss/reward function (as discussed in detail below) is compiled at operation 55 based, at least in part, on the feedback data obtained in the operation 54. Then, at operation 56, a model is updated using the loss/reward function. As discussed in detail below, that model may be used in the generation of the channel quality metric offset.

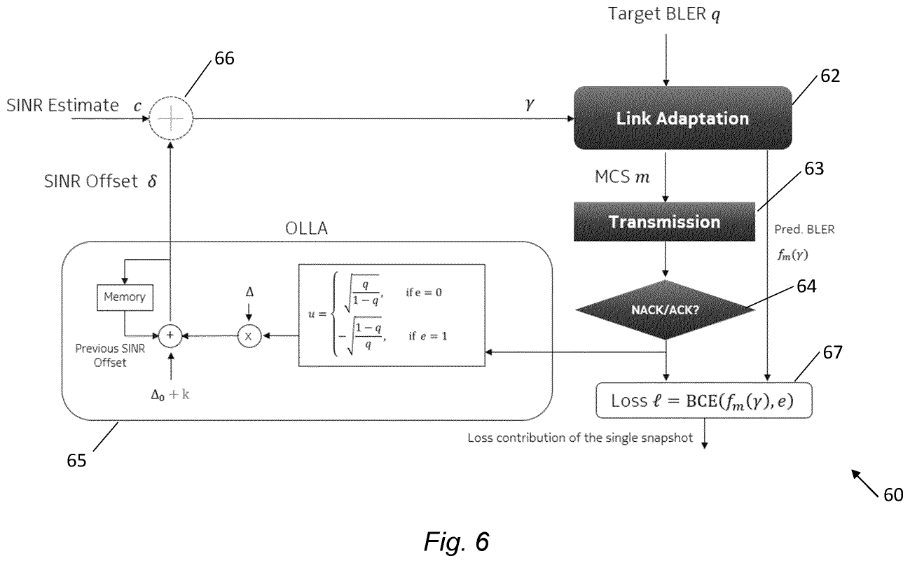

FIG. 6 is a block diagram of a system, indicated generally by the reference numeral 60, in accordance with an example embodiment. The system 60 may be used to implement the algorithm 50 and variants thereof, as discussed in detail below.

The system 60 comprises a link adaptation module 62, a transmitter 63, a feedback module 64, an outer look link adaptation (OLLA) module 65, a summing module 66 and a loss/reward function module 67.

In the system 60, the link adaptation module 62 receives and generates a highest rate modulation and coding scheme (MCS) that satisfies the target BLER q based on a signal-to-noise-plus-interference ratio (SINR) estimate from the summing module 66. The link adaptation module 62 is therefore similar to the link adaptation module 32 described above.

In a similar manner to the summing module 38 described above, the summing module 66 generates the SINR estimate γ(τ) by correcting the most recent SINR estimate c (e.g. obtained from Channel Quality Indicator (CQI) feedback) using an OLLA offset δ(τ) at time r, leading to the SINR estimate:

$$γ ( τ ) = c + δ ( τ )$$

The OLLA offset (sometimes referred to as a channel quality metric offset) may be based, at least in part, on a target error rate (e.g. BLER) for transmissions using the mobile communication system.

The transmitter 63 coverts data symbols into transmit symbols in accordance with the modulation scheme set by the link adaptation module 62 and the feedback module 64 provides an ACK/NACK message (or some other acknowledgement signal) indicative of whether a previous transmission over the relevant channel was successful.

The OLLA module 65 receives an ACK/NACK message and updates the SINR offset as discussed further below.

As discussed in detail below, the loss/reward function module 67 may be used to generate a loss/reward function based on a predicted error rate and the feedback signal obtained from the feedback module 64.

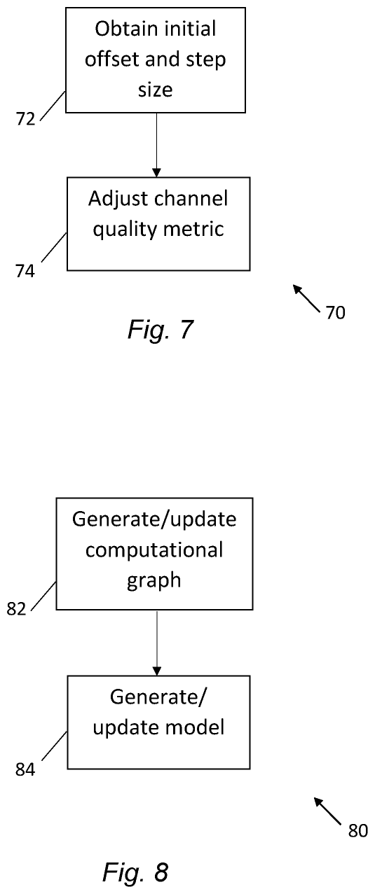

FIG. 7 is a flow chart of an algorithm, indicated generally by the reference numeral 70, in accordance with an example embodiment. The algorithm 70 shows an example use of the OLLA module 65

The algorithm 70 starts at operation 72, wherein an initial offset value Δ₀ and an average offset step size Δ are obtained from a model.

At operation 74, the channel quality metric offset δ is increased or decreased depending on the feedback signal received from the feedback module 64. The amount of the change in the channel quality metric offset δ is dependent on many variables, including the average offset step size Δ obtained from the model and the BLER.

The algorithm 70 can be used to provide an offset to the SINR estimate c received at the summing module 66. As discussed in detail below, the model is used to update the OLLA parameters over time, during the use of the system 60.

In the use of the system 60, we start by considering a set of OLLA parameters, namely A and Δ₀, associated to each desired target BLER q. We then build a computation graph that allows to determine the effect of each input and OLLA parameter on every variable in the system and, in particular, on a loss score [symbol] that represents how much the sequence of MCS' predicted BLER fₘ(γ) is different from the experienced first transmission's ACK/NACKs e. The Boolean variable e assumes value 1 and 0 with NACK and ACK respectively.

FIG. 8 is a flow chart of an algorithm, indicated generally by the reference numeral 80, in accordance with an example embodiments.

The algorithm 80 starts at operation 82 where the computational graph comprising the channel quality metric, the channel quality metric offset, the modulation and coding scheme and the feedback signal discussed above is generated or updated. Then, at operation 84, the relevant model is generated or updated. The model can then be used to provide the OLLA parameters to the OLLA module 65. The computational graph (and hence the model) can then be updated over during (e.g. during the use of the system 60).

In an example use of the system 60, we have as input at the Time Transmission Interval (TTI) τ:
The most recent CQI report c(τ)
The SINR offset δ(τ)

We consider a delay between a transmission and its ACK/NACK reception of D TTIs.

Note that the SINR offset update is typically done considering only the first packet transmission attempt. We define

$$F = \sqrt{\frac{q}{1 - q}} .$$

With some mathematics, one can write the SINR offset as follows:

$$δ ( τ ) = {Δ}_{0} + Δ {\sum }_{t = 0}^{τ - D} \{ \begin{matrix}0 & if no transmission at TTI t \\ + F & if tx at TTI t and e ( t ) = 0 \\ - {F}^{- 1} & if tx at TTI t and e ( t ) = 1\end{matrix} = {Δ}_{0} + Δ ρ ( τ )$$

Therefore, we have that the SINR estimate: γ(τ)=c+δ(τ).

One can then use the SINR estimate to perform the MCS selection, using parametrized BLER curves for every MCS (e.g. using Sigmoid or Error Function BLER curves). (In the description below, we generally assume that Sigmoid functions are used due to the high numerical stability, but in principle any generic parametrized formula can be used.) Therefore, we have that the BLER curve for the generic MCS m can be written as:

$${BLER}_{m} ( γ ) = {f}_{m} ( γ ) = σ ( {α}_{m} ( γ - {γ}_{m} ) )$$

where αₘ and γₘ are the slope and the transition point of the MCS m and σ(x)=(1+e^{-x})⁻¹. Note that the BLER curve may depend also on other parameters, e.g. the transport block size. The MCS selection can be performed in any way, but one typically applies the concept of selecting the MCS \hat{m}, such that it is the highest rate MCS that satisfies the first transmission target BLER, i.e. fₘ(γ)≤q.

Therefore, at TTI τ, the MCS \hat{m}(τ) is selected and we can write the sigmoid input as follows:

$$ι ( τ ) = {α}_{\hat{m} ( τ )} ( γ ( τ ) - {γ}_{\hat{m} ( τ )} )$$

We leave the Sigmoid operation out, since when computing (and, later, backpropagating) the loss function we propose, numerical stability may be improved when sigmoid is applied directly in the loss computation. We propose to measure the performance of the whole LA process, by computing (using the loss/reward function module 67) the Binary Cross Entropy (BCE) between the predicted BLER at time T for the selected MCS \hat{m}(τ) and the experienced ACK/NACK for a transmission happening at time τ, e(τ). Since the input was computed without taking the Sigmoid operation, we may use the concept of Binary Cross Entropy with Logits Loss, to improve stability:

$$ℓ ( τ ) = e ( τ ) log ( σ ( ι ( τ ) ) ) + ( 1 - e ( τ ) ) log ( 1 - σ ( ι ( τ ) ) ) \qquad ( 1 )$$

Other more complex alternatives could be the Hinge loss with hyperbolic tangent activation function, but in principle this concept could work with any derivable composition of loss and activation functions (that in the equation (1) above are simply combined in the unique Binary Cross Entropy with Logits Loss).

The derivatives of the loss function [symbol] (τ) with respect to the SINR offset can be then obtained thanks to the backpropagation properties of computation graphs when computing derivatives:

$$\frac{\partial ℓ ( τ )}{\partial ι ( τ )} = σ ( ι ( τ ) ) - e ( τ )$$

$$\frac{\partial ι ( τ )}{\partial γ ( τ )} = \frac{\partial ι ( τ )}{\partial δ ( τ )} = {α}_{\hat{m} ( τ )}$$

$$\frac{\partial δ ( τ )}{\partial {Δ}_{0}} = 1$$

$$\frac{\partial δ ( τ )}{\partial Δ} = ρ ( τ )$$

Therefore, we have a generic way to backpropagate derivatives of the loss function to the SINR offset, allowing to train the parameters that generated it. If we take one step further:

$$\frac{\partial ℓ ( τ )}{\partial {Δ}_{0}} = {α}_{\hat{m} ( τ )} \frac{\partial ℓ ( τ )}{\partial ι ( τ )} \qquad ( 2 )$$

$$\frac{\partial ℓ ( τ )}{\partial Δ} = {α}_{\hat{m} ( τ )} \frac{\partial ℓ ( τ )}{\partial ι ( τ )} ρ ( τ ) \qquad ( 3 )$$

one could allow the training of OLLA parameters Δ₀, Δ.

For instance, one may consider all the contributions to Equations (2) and (3) from every first transmission from active users transmitting with target BLER q. The obtained data can be aggregated in many ways, for instance by aggregating (summing/averaging/taking linear combinations of) all N contributions from each single user independently within a window of T TIIs, obtaining N samples. These samples can be used to update the OLLA parameters, by using the computed derivatives for each sample. Data can be split in mini-batches of n<N and different update mechanisms can be used, e.g. stochastic gradient descent or Adam. The data can be used one time (single epoch) or iterated multiple times.

One could also use mechanisms not relying on derivatives to optimize the search, like Gaussian Processes/Bayesian Optimization. Indeed, the skilled person will be aware of many possible approaches.

The new updated OLLA parameters can then be used from that moment in the cell, allowing each single base station to train their OLLA parameters (during operation) without the need of manually configuring them and searching their optimal values. Moreover, each single base station can learn (thanks to proper learning rate settings) to adapt these parameters, following the current situation in the cell (e.g. using a lower Δ₀ if strong interference is observed in that scenario, whilst a more stable cell where interference is not a problem can be more aggressive).

If one does not use sigmoid regression for the BLER curves, but a generic function fₘ(γ), one could modify the loss function (1) by writing:

$$ℓ ( τ ) = e ( τ ) log ( {f}_{m} ( γ ( τ ) ) ) + ( 1 - e ( τ ) ) log ( 1 - {f}_{m} ( γ ( τ ) ) )$$

Accordingly, the derivatives become:

$$\frac{\partial ℓ ( τ )}{\partial {f}_{m} ( γ ( τ ) )} = \frac{( {f}_{m} ( γ ( τ ) ) - e ( τ ) )}{{f}_{m} ( γ ( τ ) ) ( 1 - {f}_{m} ( γ ( τ ) )}$$

$$\frac{\partial {f}_{m} ( γ ( τ ) )}{\partial γ ( τ )} = \frac{\partial {f}_{m} ( γ ( τ ) )}{\partial δ ( τ )}$$

$$\frac{\partial ℓ ( τ )}{\partial δ ( τ )} = \frac{\partial ℓ ( τ )}{\partial {f}_{m} ( γ ( τ ) )} \frac{\partial {f}_{m} ( γ ( τ ) )}{\partial γ ( τ )}$$

And then continue with the ∂δ(τ)/∂X backpropagation where X is the generic parameter (e.g. Δ or Δ₀).

$$\frac{\partial ℓ ( τ )}{\partial {Δ}_{0}} = \frac{\partial ℓ ( τ )}{\partial δ ( τ )} \qquad ( 4 )$$

$$\frac{\partial ℓ ( τ )}{\partial Δ} = \frac{\partial ℓ ( τ )}{\partial δ ( τ )} ρ ( τ ) \qquad ( 5 )$$

A number of variants to the principles described are possible, as discussed further below.

An extension of the invention could be to consider, instead of the OLLA simple operations, a more complex function to compute the SINR Offset to be used to correct the SINR estimate. If one wants to adopt the same procedures so far described, the function approximator should be derivable.

For instance, a generic NN can substitute the OLLA module 65 described above to estimate the SINR offset. Then, many extensions can be used when adopting NN, like:
Using as input a sequence from one (multiple users), to allow training of time-coherent layers, like RNN, GRU, LSTM or CNN.
Input also other information in addition to the previous ACK/NACK, for instance:
   The current SINR estimate (most recent CQI); or
   The gap between the current SINR and the required SINR to achieve the desired first transmission target BLER q.
Output other values, like predicted SINR values and their quantiles and use the knowledge of the true experienced knowledge (e.g. available in simulators) to support NN training. This can be done by adding a loss component measuring the error between the SINR predictions and the true value.

So far, we have discussed of using and training different OLLA parameters for each different first transmission target BLER q that the base station must handle. One could extend this concept to keep a table of learnable OLLA parameters, discriminating also on other conditions (hyper-parameters), such as:
Low/mid/average load;
Different hours in the day;
Number of antennas at the user terminal;
User position, that can be communicated by the user itself or inferred by the base station, if it has good enough beamforming capabilities;
Single User (SU) vs. Multi User (MU) transmissions, i.e. number of parallel transmissions on the same resource;
Other user hyper-parameters describing its hardware, like noise figure, number of quantization bits at the ADC, etc. . . . .

This would allow the training of the OLLA parameters of the table's entry corresponding to the specific hyper-parameters. Therefore, one can differentiate between the macro-conditions that could impact the system behaviour.

One could generalize the use of the computational graph discussed above. For example, instead of handling a table and updating only the entry corresponding to the hyper-parameters of interest, one could input the hyper-parameters of interest to a generic parametric function, e.g. a NN that outputs the OLLA parameters to be used.

If the generic parametric function has defined derivatives (hereafter NN), one can further backpropagate derivatives of the loss function [symbol] beyond the OLLA parameters. One can extend the chain rule to backpropagate derivatives to also estimate the NN parameters, allowing to get the optimized OLLA parameters for every possible hyper-parameters' realization.

This approach keeps the possibility of easy debugging, since the output of NN are the plain values of OLLA parameters to be used for every realization, allowing to put ad-hoc rules and limitations on top of the NN output (by e.g. clamping its output) to make sure that the system does not assume undesired behaviours.

If the transmissions of a user are sporadic, the role of CQI reports (e.g. SINR estimates) becomes relevant in allowing a base station to be aware of the current channel quality measured by the mobiles. In this context, the OLLA correction term δ has the job to keep sure that the long-term first transmission target BLER q is matched.

However, in case of frequent transmissions, e.g. multiple transmissions within a CQI update period, the OLLA correction term is updated more frequently. In this case, δ may represent a fresher estimate of the correct offset between the CQI and the actual channel condition. Therefore, one should properly fuse the information carried by updated CQIs and OLLA correction term.

If the SINR estimate is updated for the u-th time with a new value c(u)≠c(u−1), where c(u−1) is the old value, we propose to update the OLLA correction term as follows:

$$δ ( τ ) := δ ( τ ) + k ( c ( u - 1 ) - c ( u ) )$$

where k is the CQI Correction Term (CCT). The use of the CCT term k is shown in the OLLA module 65 of the example system 60.

Note that with k=0 one would obtain the non-updated correction term, while with k=1 there will be no discontinuity in the estimated corrected SINR γ(τ) at the reception of a new CQI update. The benefits of this approach are discussed further below.

In some example embodiments, continuous transmissions are provided, therefore it makes no sense not to have a fixed k in such embodiments. However, one may want to have a variable value for the CCT, depending on how often the user/bearer is transmitting compared to the CQI report period. For instance, a proposal could be to track (e.g. moving average or exponential smoothing) the ratio R between the average number of transmissions in a CQI period and the CQI period itself. Then, one could use as CCT a generic parametric formula increasing with R, for instance

$$k ( R ) = {k}_{0} ( 1 - {e}^{- {k}_{1} R} )$$

where k₀ and k₁ are positive parameters. Note that the case of constant k can be obtained with setting k₁=+∞, since R>0.

One could then update/add the forward and backward steps to optimize also the CCT with the OLLA training techniques presented earlier, assuming to have experienced U(τ) overall CQI updates in the system before time τ, each with a corresponding CQI value c(u) and transmission ratio R(u).

The forward pass of the OLLA correction term becomes:

$$δ ( τ ) = {Δ}_{0} + Δ ρ ( τ ) + {k}_{0} {\sum }_{u = 1}^{U ( τ )} ( 1 - {e}^{- {k}_{1} R ( u )} ) ( c ( u - 1 ) - c ( u ) )$$

The derivatives can be computed as:

$$\frac{\partial ℓ ( τ )}{\partial {k}_{0}} = \frac{\partial {f}_{m} ( γ ( τ ) )}{\partial δ ( τ )} {\sum }_{u = 1}^{U ( τ )} ( 1 - {e}^{- {k}_{1} R ( u )} ) ( c ( u - 1 ) - c ( u ) ) ,$$

that in case of constant CCT is

$$\frac{\partial ℓ ( τ )}{\partial {k}_{0}} = \frac{\partial {f}_{m} ( γ ( τ ) )}{\partial δ ( τ )} ( {c}_{0} - c ( τ ) ) .$$

Regarding the parameter k₁, we have:

$$\frac{\partial ℓ ( τ )}{\partial {k}_{1}} = \frac{\partial {f}_{m} ( γ ( τ ) )}{\partial δ ( τ )} {k}_{0} {\sum }_{u = 1}^{U ( τ )} ( {k}_{1} R ( u ) {e}^{- {k}_{1} R ( u )} ) ( c ( u - 1 ) - c ( u ) )$$

In the Neural Network literature, gradient detaching (GD) has been used to reduce the complexity of back-propagation operations with recurrent layers, e.g. long short term memory (LSTM). With GD, one can remove, in the computational graph, previous dependencies that generated a variable, that is thereafter seen as a constant. This reduces the time needed to back-propagate derivatives, but without allowing the network to learn long-term dependencies.

However, given the simple formulations used in example embodiment described herein, there are not gated units like in LSTM that would allow to capture long-term dependencies, but rather all data is used to determine the derivatives with respect to the initial offset Δ₀, step size Δ and CCT. Therefore, in one example embodiment, it is proposed herein to apply GD after an initialization period, to allow only the first τ′ TIIs to influence the derivatives of Δ₀. One could detach gradients of Δ₀ only, but in this example embodiment we consider detaching the derivatives (δ(τ′). Therefore, we can write the equation δ(τ)=Δ₀+Δρ(τ)+Γ(τ) as:

$$δ ( τ ) = {δ ( {τ}^{′} )}^{GD} + Δρ ( τ , {τ}^{′} ) + Γ ( τ , {τ}^{′} ) , with τ > {τ}^{′}$$

where δ(τ′)^{GD} is seen as a constant during backpropagation and ρ(τ,τ′) and Γ(τ,τ′) have the same expression of ρ(τ) and Γ(τ, τ′), respectively, but computed from the detaching TTI τ′. Accordingly, we can derive the equations:

$$\frac{\partial δ ( τ )}{\partial {Δ}_{0}} = 0 ,$$

$$\frac{\partial δ ( τ )}{\partial Δ} = ρ ( τ , {τ}^{′} ) = ρ ( τ ) - ρ ( {τ}^{′} ) ,$$

$$\frac{\partial δ ( τ )}{\partial {k}_{0}} = c ( {τ}^{′} ) - c ( τ ) .$$

After GD, derivatives are non-zero only for the OLLA step and the CCT. Note that GD could be applied multiple times during training, but this did not seem to provide considerable effects apart from the initial detaching at TTI τ′.

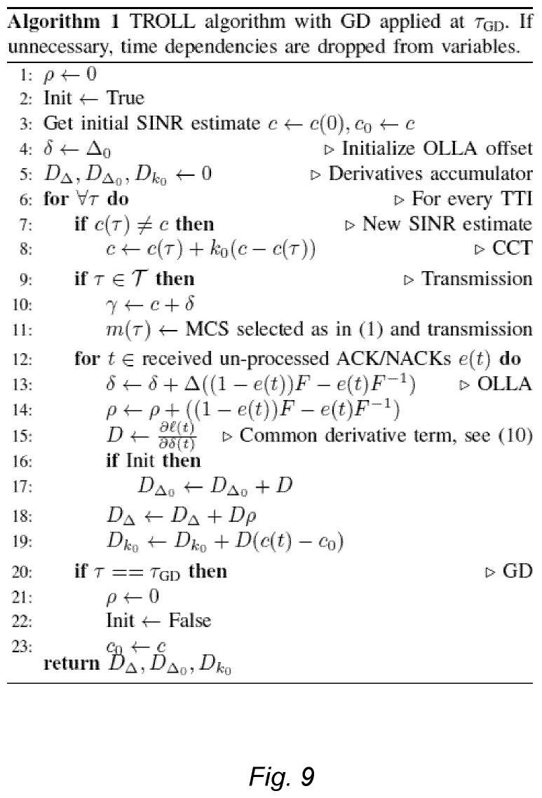

FIG. 9 shows an algorithm (Algorithm 1) in accordance with an example embodiment. Algorithm 1 is a practical implementation of the algorithms described herein applied to a single user, including initial GD at time τ_{GD} and fixed CCT k(u)=k₀. The returned values are the derivatives with respect to Δ, Δ₀, k₀ respectively.

A simulation setup to validate the proposals described above was developed consisting of two elements. First, we generated traces of true SINR and predicted CQI reports in a Downlink (DL) 3GPP compliant system level simulator, that perform operations with fixed LA parameters. This will consist of our data that we will use for our experiments in a custom AI_LA Python/Pytorch-based implementation of the OLLA update algorithms described herein.

The main parameters/assumptions used to generate the data with the system-level simulator are reported in Table 1 below.

TABLE 1
Main system level simulator parameters

| Parameter | Value | |
|---|---|---|
| 3GPP scenario | 3GPP 3D Urban Macro (UMa) | |
| | scenario [36.873] | |
| Simulation Time | 15 seconds (15000 subframes), | |
| | 10 total experiments | |
| Number of hexagonal | 21, wrap-around interference | |
| cells | | |
| Inter-site distance | 500 | m |
| gNB antenna array | 4 × 8 × 2 cross polarized | |
| Users antenna elements | 2 vertically polarized | |
| Beamforming Algorithm | Statistical Eigen-beamforming | |
| | [VOOK + 2003] | |
| Transmit Power | 46 | dBm |
| Resource definition | 15 kHz subcarriers, 20 MHz bandwidth | |
| Scheduling | Single User Round Robin | |
| Maximum transmission | 1 | |
| rank | | |
| Number of Users per Cell | 5 | |
| Traffic model | FTP3 [36.872], packet size 2 | |
| | Mb, variable arrival rate | |
| CQI report | CQI Table 2 quantization [38.214], | |
| | period 20 ms, delay 6 ms | |
| Code performance and | LDPC channel codes, MCS table 2 | |
| MCS list | [38.212] [38.214] | |
| ACK/NACK delay | 3 | ms |

| | |
|---|---|
| SINR mapping (to a | Mutual Information |
| unique value per TTI) | Equivalent SINR Mapping |
| | (MIESM), using 256 QAM |
| | as modulation order |
| | [WAN + 2006] |

With some mathematics, we see that we have at our disposal 1050 traces of 15 seconds (15000 values) of true SINR values and the periodical CQI reports sent by mobile devices to the gNB. This data has been shuffled and split into 840 samples used for training and 210 samples for validation of the performance. All results contain performance on validation data only, that will never be seen during training. The arrival rates of the FTP3 users is dynamic and switched every 2.5 seconds between 1 and 6 packets/second per user, for a total of three cycles of 2 phases each.

We investigated the performance of number of different approaches (referred to in the figures discussed below as OLLA, TOLLA, NN LA/LA-Net) in a Python/Pytorch based implementation with the parameters and assumptions reported in Table 2, where the instantaneous SINR and CQI report sequence of every user are used as input datasets. Note that we consider TIs as unit of time hereafter. We considered continuous transmissions from every user. Given constant transmissions, we considered a fixed value for the CCT parameter.

TABLE 2
Main parameters and training setup of the LA investigation

| Parameter | Value | |
|---|---|---|
| Input SINR and | From the system level simulator, see Table 1 | |
| CQI sequences | | |
| CQI delay | 20 | TTIs |
| ACK delay | 3 | TTIs |

| | |
|---|---|
| Transmission model | Continuous (emulating full buffer) |
| CCT model in TOLLA | Constant parameter (training k₀ only) |
| Code performance | LDPC channel codes, MCS table 2 |
| and MCS list | [38.212], [38.214] |
| Adam parameters | Learning rate = 0.003, other parameters as |
| | default |
| Learning Scheduler | Reduce learning rate on Validation Loss Plateaus |
| | [RVLP], |
| | Mode = ‘min’, factor = \sqrt{10}, patience = 8, |
| | cooldown = 16 |
| Target BLER q | 0.1% |
| Number of users | 8 |
| in a mini-batch | |
| Number of training | 7000 |
| iterations | |
| Validation every | 50 (saving best model if validation loss lowers) |
| x iterations | |

The investigated key performance indicators (KPIs) were the following:
BLER achieved by every user, that we want to keep close to the target.
Spectral efficiency achieved by every user, that we want to maximize (matching BLER target).
Number of consecutive failures at the beginning of a user history (first 50 ms), that we want to limit as much as possible, given the low target BLER and one of URLLC KPIs is to limit consecutive failures.
Number of double consecutive first transmission failures, that we want to keep as small as possible, allowing consecutive transmissions not to fail. One should keep in mind that, due to the ACK/NACK delay and the considered constant transmissions at every TTI, it is likely to observe consecutive NACKs in these experiments. However, in a practical system without continuous transmissions, results would be much better.

The investigated algorithms are
The baseline OLLA with different average step sizes, zero offset initialization, and no CCT enabled (true baseline OLLA implementation).
A trainable OLLA (TOLLA) in accordance with the principles described herein, with learnable average step size, initial offset and CCT value. In the experiment plotted in the Figures discussed below, the final learnt parameters were Δ₀=−6.7 dB, Δ=0.0602, k₀=0.305.
A generic neural network solution (LA-Net).

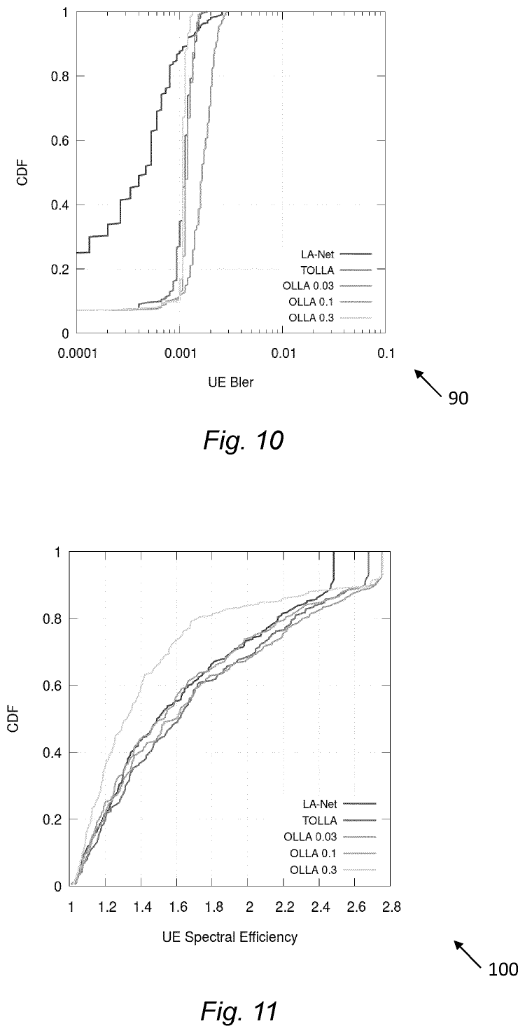

FIGS. 10, 11, 12A and 12B are plots showing results of simulations in accordance with example embodiments;

FIG. 10 is a plot, indicated generally by the reference numeral 90, showing the BLER CDFs achieved by the users.

The LA-Net approach is more conservative than the target BLER of 0.1%. This is due to the finite MCS tables and the selection of an MCS, whose BLER is below the target. Due to the absence of the OLLA mechanism, the LA-Net is not forced to match the BLER on the long run.

Note how the TOLLA algorithm with an optimized average step size of Δ=0.0602 can enforce the desired BLER for all its users, keeping the same performance of the OLLA baseline with the manually optimized average step sizes of 0.1 and 0.3. One should notice that these values are clearly scenario dependent and TOLLA could optimize them without the need of any manual tuning.

FIG. 11 is a plot, indicated generally by the reference numeral 100, showing the spectral efficiencies of the user devices (UEs).

In the plot 100, we can immediately notice that the LA-Net approach is not able to achieve the highest spectral efficiencies, probably due to the lack of consistent training data at high SINR regimes. Nevertheless, we can appreciate the spectral efficiency comparable to the other OLLA/TOLLA algorithms at low-mid spectral efficiencies that can be achieved with much lower BLERs (from previous figure).

The TOLLA algorithm can stay in the middle on the OLLA pack, achieving higher top spectral efficiencies compared to LA-Net.

The OLLA baselines start degrading at too high OLLA step (a well-known problem), due to its too conservative correction. Notice how the promising OLLA 0.3 from the BLER CDF in the plot 90 will here deliver a too low spectral efficiency, clearly showing the trade-off between BLER and spectral efficiency that needs to be taken into account for the average step size when considering plain OLLA. The only remaining OLLA baseline seems to be the 0.1 step size

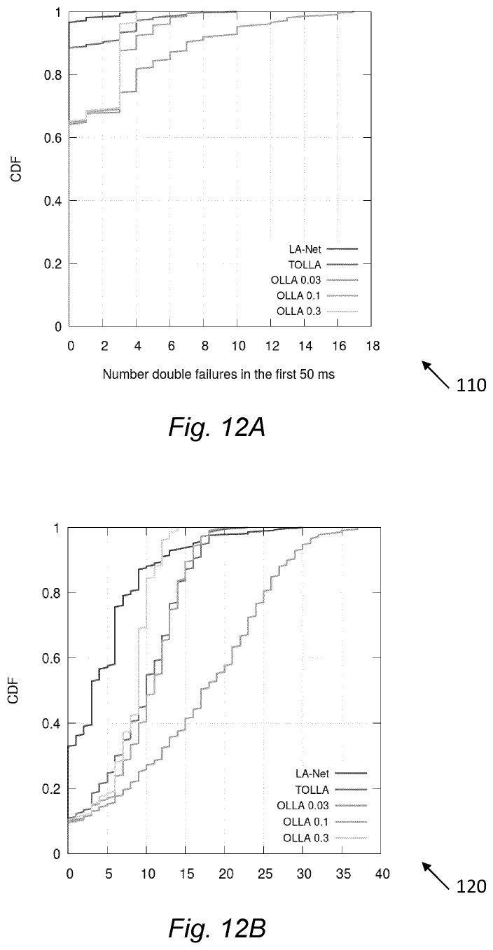

FIG. 12A is a plot, indicated generally by the reference numeral 110, showing the number of consecutive failures at initialisation in accordance with an example embodiment.

FIG. 12B is a plot, indicated generally by the reference numeral 120, showing the number of consecutive failures in total in accordance with an example embodiment.

Note that at initialization (the plot 110) one could have failures due to convergence and, during runtime (the plot 120), one could have failures due to the ACK/NACK delays. LA-Net is clearly outperforming all its competitors at initialization. During the whole experiment, its performance gets more diverse, due to rather small amount of training data available that did not allow to cover some cases. Still it remains the most robust algorithm.

The TOLLA algorithm described herein is the next best performing candidate. Minor initialization issues and around 15 failures across the experiment.

OLLA 0.1 is the only one keeping up with TOLLA, the other step sizes are either too conservative or too aggressive. Less double failures could be observed with OLLA 0.3, but they would disappear also with TOLLA and other OLLA baselines without constant transmissions (that is the case with URLLC).

In summary, the LA-Net approach remains an interesting solution to maybe generalize and improve performance when scenarios become more diverse and more input information can be leveraged. However, its implementation efforts and computational complexity make its practical implementation in a product rather difficult.

On the other hand, the TOLLA algorithm described herein allows for OLLA parameters optimization at runtime, given the simplicity of its parameter optimizations. One would require only few multiplication/additions to compute the derivatives contribution at every transmission, accumulate them, and taking parameter steps on periodical time windows. As we saw in the results, TOLLA is able to find the best OLLA performing working point, even improving with respect to it, given its optimized initialization and CCT.

The system 60 is one example approach for seeking to select an optimal modulation and coding scheme (MCS) for link adaptation. However, alternative approaches exist.

In order to select optimal modulation and coding scheme (MCS) for uplink transmissions traditional link adaptation (LA) requires signal-to-interference-plus-noise ratio (SINR) measurements and HARQ information regarding whether previous reception was successful or not. Often LA implementation is divided into inner-loop link adaptation (ILLA) and outer-loop link adaptation (OLLA), as discussed above. ILLA selects MCS based on SINR measurements and OLLA provides an offset for addition to the SINR measurement. Failed retransmissions can be used to direct SINR towards more robust direction and successful transmissions towards less robust direction for each UE separately. This allows selecting block error rate (BLER) target for which OLLA algorithm aims at.

Traditional OLLA algorithms have been proven to work well for traditional mobile broadband (MBB) traffic, for which optimal BLER target is around 0.1 (10%) for throughput maximization. Such algorithms can converge to more robust BLER targets as well, but for requirements currently being discussed at 3GPP, heritage OLLA may not be the optimal solution. For example, augmented reality (AR), virtual reality (VR) and cloud gaming (CG) applications may require reliability of 0.9999 for the whole internet protocol (IP) packets with <10 ms latency, where uplink (UL) packet inter-arrival time may be around 4 ms.

Another problem with traditional OLLA is that exhaustive search for optimal OLLA parametrizations is not realistic for each UE separately. Thus, educated guesses about adequate OLLA BLER offsets have to be used.

Furthermore, OLLA can cause high occasional peaks in packet delays. For example, if a gNB cannot decode uplink transmission correctly, the gNB may immediately make subsequent transmissions more robust. This increases number of resource blocks (RBs) required for transmitting a single packet. Such load increase causes scheduling delays and additional interference for other UEs as well, especially if multiple UEs start experiencing errors at the same time.

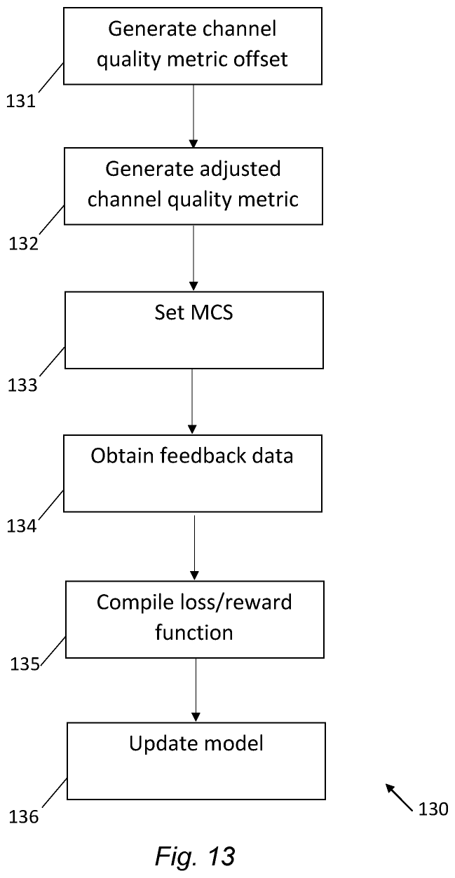

FIG. 13 is a flow chart of an algorithm, indicated generally by the reference numeral 130, in accordance with an example embodiments.

The algorithm 130 starts at operation 131, where a channel quality metric offset δ(τ) is generated. As described in detail below, the channel quality metric offset is generated, in one example embodiment, by a model (e.g. a machine-learning model).

At operation 132, a channel quality metric, such as SINR, denoted herein by c, is summed with the channel quality metric offset generated in the operation 131 in order to generate an adjusted channel quality metric γ(τ) of a channel of a mobile communication system (such that γ(τ)=c+δ(τ)).

A modulation and coding scheme (MCS) is set in operation 133 for use in transmitting data over the channel. The MCS is generated based, at least in part, on the adjusted channel quality metric γ(τ).

At operation 134, feedback data relating to the success of data transfer over said channel are obtained. In the example described above. such data may comprise ACK/NACK signals, but this is not the only possibility. As discussed further below, the feedback signal may include an indication of whether a transmission of a packet of data (e.g. a PDCP packet) was successful.

A loss/reward function (as discussed in detail below) is compiled at operation 135 based, at least in part, on said feedback data obtained in the operation 134. Then, at operation 136, a model is updated using the loss/reward function. As discussed in detail below, that model is used to generate the channel quality metric offset in the operation 131.

The algorithm 130 may replace the traditional OLLA with a machine learning based approach for generating SINR offsets for ILLA. Moreover, cumulative resource block (RB) usage caused by PDCP PDUs being transmitted successfully can be used as an input to the machine learning procedure. Additionally, other information such as failed PDCP packet receptions or packet delay budget (PDB) violations can be taken into account. The ML method may aim to minimise cumulative RB consumption generated by single PDCP PDUs without generating transmission errors or violating packet delay budget. Accumulated RB consumption can be calculated as sum of all RBs used for transmitting new transmission including all segments as well as all required repetitions and/or retransmissions if any.

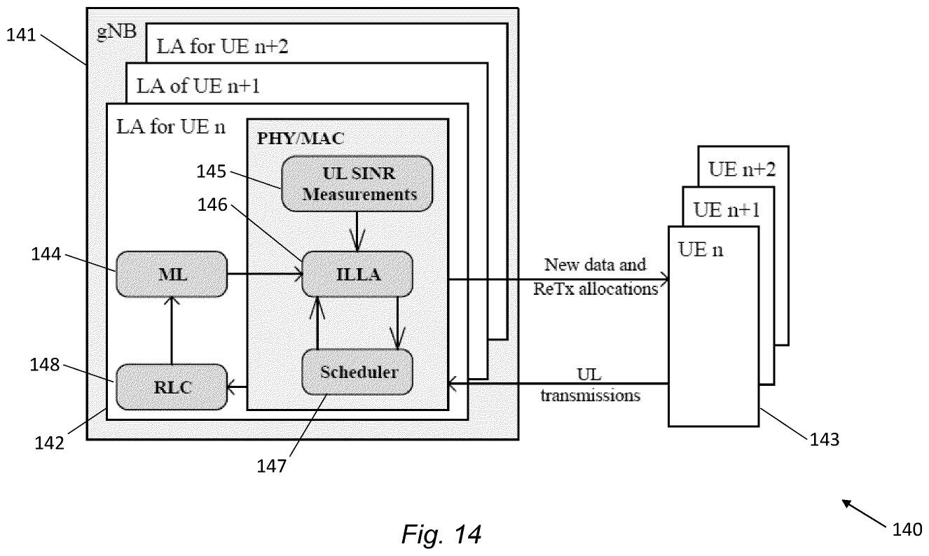

FIG. 14 is a block diagram of a system, indicated generally by the reference numeral 140, in accordance with an example embodiments. The system 140 may be used to implement the algorithm 130.

The system 140 comprises a gNB 141 (or some other mobile communication node) comprising a plurality of link adaptation modules 142. The gNB 141 is in communication with a plurality of user devices (UEs) 143. A separate link adaptation module 148 may be provided for generating an MCS for each user device. (Thus, the −channel quality metric offset as described herein may be a user device-specific offset.) The example link adaptation module 142 comprises a machine learning (ML) module 144, an uplink (UL) SINR measurement module 145, an ILLA module 146, a scheduler 147 and a radio link control (RLC) module 148.

The ML module 144 generates a channel quality metric offset δ(τ) and provides that offset to the ILLA 146, thereby implementing operation 131 of the algorithm 130.

The UL SINR measurement module 145 provides a SINR measurement to the ILLA 146 (although some other channel quality SINR could be provided in an alternative embodiment).

The channel quality metric (such as SINR) received from the UL SINR measurement module 145 and the offset received from the ML module 144 are summed to generate an adjusted channel quality metric γ(τ) of a channel of a mobile communication system, thereby implementing operation 132 of the algorithm 130.

A modulation and coding scheme (MCS) is set by the ILLA 146 based, at least in part, on the adjusted channel quality metric, thereby implementing the operation 133 of the algorithm 130.

The scheduler 147 and the RLC module 148 determine whether a Packet Data Convergence Protocol (PDCP) packet is completely received (i.e. fully assembled at radio link control (RLC) layer 148). Accumulated physical resource block (PRB) usage and whether PDCP PDU delivery was successful or not is fed to the ML module 148, thereby implementing operation 134 of the algorithm 130. Also additional information such as possible packet delay budget (PDB) (and/or survival time) violation event may be provided.

A loss/reward function is (implementing the operation 135) based, at least in part, on said feedback data obtained in the operation 134. Then, the ML model 144 is updated using the loss/reward function, thereby implement operation 136 of the algorithm 130.

The ML module 148 may then update its suggestion towards optimal SINR offset for inner-loop link adaptation (and provide that suggestion to the ILLA module 146). Note that this approach does not react to individual successful or unsuccessful transmissions, instead the ML model keeps constantly learning offset that minimizes radio resource usage without missing any PDCP PDUs UE attempts to transmit.

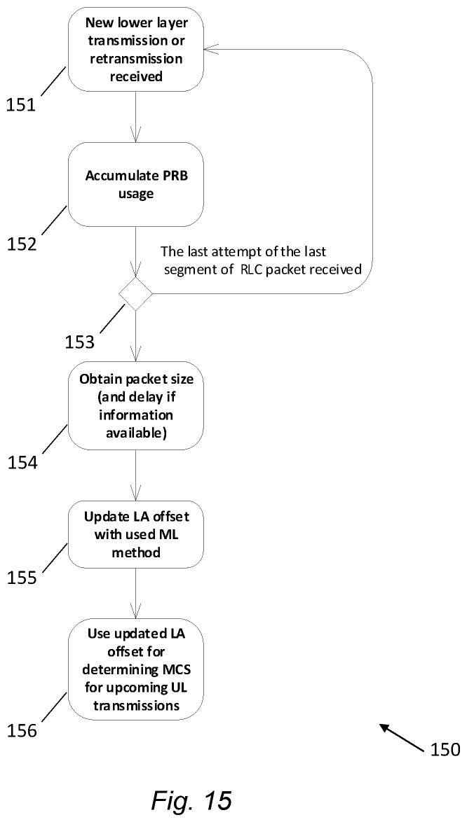

FIG. 15 is a flow chart of an algorithm, indicated generally by the reference numeral 150, in accordance with example embodiments. The algorithm 150 may be implemented using the system 140.

The algorithm 150 starts at operation 151, where new transmission or retransmission at lower layers is received. At operation 152, the gNB accumulates physical resource block (PRB) usage for associated data flow (or associated PDCP packets).

At operation 153, a determination is made regarding whether the transmission/reception of the relevant packet of data is complete. If so, the algorithm moves to operation 154; otherwise the algorithm returns to operation 151.

At operation 154, the packet size is determined. Furthermore, delay information may be obtained, if available.

At operation 155, the ML model is used to update the channel quality metric offset (which offset is provided to the ILLA). The ML model may be updated at this stage.

Finally, at operation 156, the updated offset as generated in the operation 155 is used for determining MCS for upcoming uplink transmissions.

In some example embodiments, a UE may provide additional information that could further improve learning of the ML model. For example, the UE could provide indications whenever it notices that a packet violates a packet delay budget (PDB) or survival time. In case of uplink, the UE has knowledge about the time when packet arrives for transmission. Hence, tracking uplink packet delays may be more accurate at UE that at a gNB.

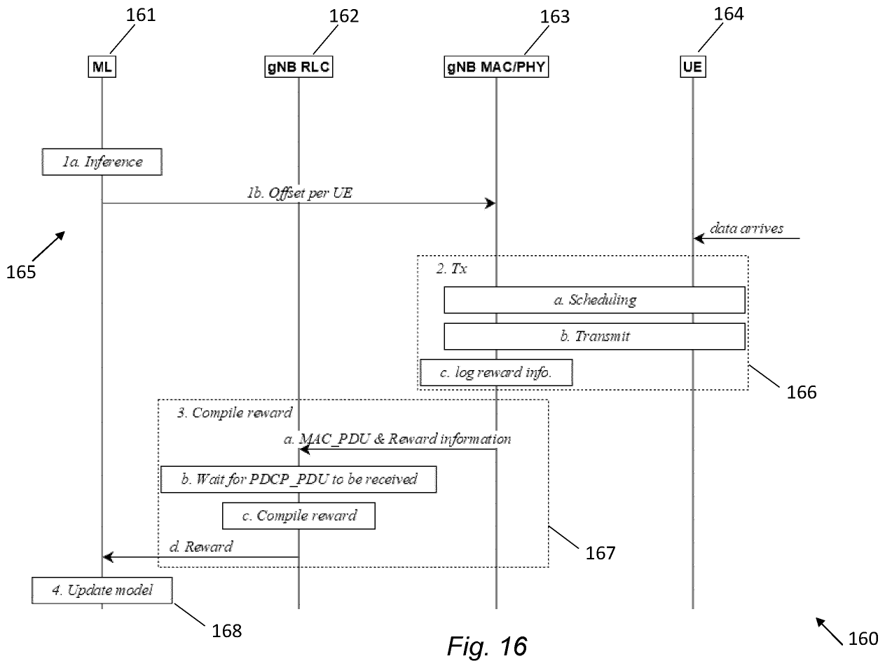

FIG. 16 is a signalling diagram, indicated generally by the reference numeral 160, in accordance with an example embodiment. The signalling diagrams shows signals between a machine learning (ML) module 161 (such as the ML module 144), gNB radio link control (RLC) module 162 (such as the RLC module 148), gNB MAC/PHY layer 163 and a user device (UE) 164 (such as the UEs 143).

In the signalling diagram 160, the ML module 161 may be located in different logical entity to the RLC and PHY/MAC layers. Even though the implementation may be in gNB, in some architectures (e.g. DU/CU split), the ML model may be in different physical location than some RAN layers. For example, the ML module 161 could be in the RLC and connected to PHY/MAC via an interface, the ML module could be located in the PHY/MAC or the ML module could be outside the RAN.

The signalling diagram 160 shows messages generated and transferred in four phases (first to fourth phases 165 to 168 respectively).

In the first phase 165, an offset is provided for the MAC/PHY layer 163.

The first phase 165 starts with inference, which comprises exploration and exploitation according to epsilon-greedy principle. With probability p we select a random action and with probability 1−p action is select from the Q-table. The p is decreased every inference until it reaches minimum exploration probability p_min. The ML model 161 provides the inference output for PHY/MAC layer 163 and UE ID for which the offset is intended

In another embodiment, if the ML model input depends on user measurement (e.g. CQI), PHY/MAC layer 163 would signal the UE ID and measurement for ML entity, and get the offset as response.

The second phase 166 is a transmission phase.

When data arrives at the UE 164, the UE requests resources from the gNB as defined by the relevant standard. During transmission, gNB link adaptation (LA) implementation applies the UE specific offset (received in the first phase 165) to a CQI to MCS mapping function.

The MAC layer logs the necessary information for later ML training (e.g. RB usage per MAC_PDU, optionally error probabilities of each re-tx).

In the third phase 167, a reward is compiled, for use in training the ML model.

The MAC forwards MAC_PDU and the ML reward information to the gNB RLC 162. The RLC 162 waits until PDCP_PDU is complete and then compiles the relevant reward, as discussed in detail above. The reward function is then forwarded to the ML module 161.

In the fourth phase 168, the ML model is update, for example according to Q-learning principles, using the reward generated in the third phase 167.

Although not show in FIG. 16, the message sequence the returns to the first phase 165.

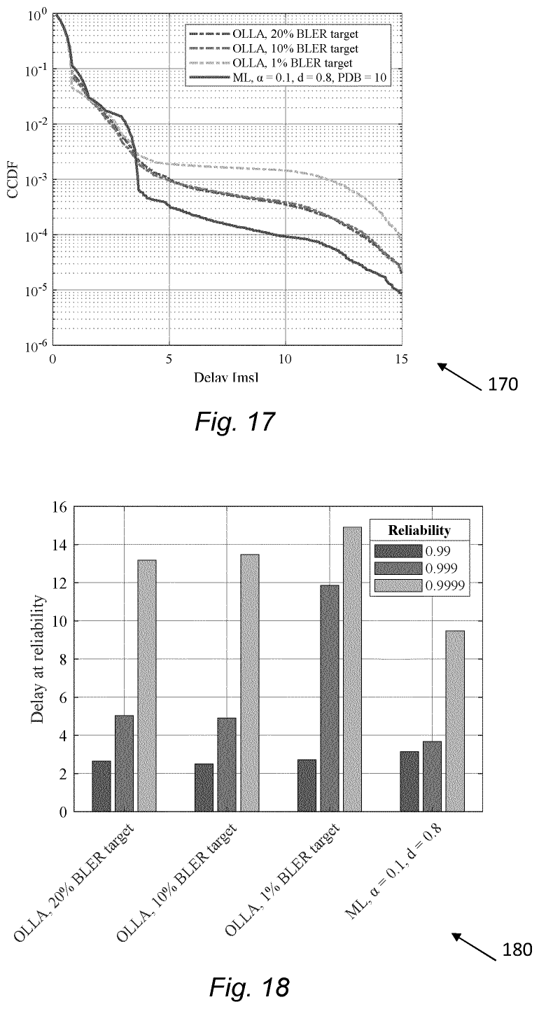

In order to prove the technical feasibility of proposed ML assisted link adaptation, system level simulations were carried out with realistic 5G NR simulator (FREAC). FIGS. 17 to 19 are plots, indicated generally by the reference numerals 170 to 190 respectively, showing results of simulations in accordance with example embodiments. In the simulations, we replaced FREAC's traditional OLLA implementation with proposed ML approach and compared its performance with traditional OLLA. The machine learning algorithm used the Q-learning approach. As input to implemented ML entity we used cumulative resource block (RB) usage of PDCP packets.

Additionally, whether the packet failed or not, and information whether gNB was able to schedule packet and its possible retransmissions within selected threshold was used. In our simulations this threshold was set to match packet inter-arrival time, which was 4 ms. That way we encouraged ML to try get rid of old packets before new arrived for transmission. Thus, our reward function was as follows:

$$R = \frac{T / ( {\sum }_{i = 1}^{n} {k}_{i} ( 1 + {p}_{i} ) )}{2} + {F}_{e r ror} ,$$

Where T is received data in bytes i.e. packet size, kᵢ is number of RBs used for i-th received transmission including (new or retransmitted) data of received PDCP packet, and Fₑᵣᵣₒᵣ is optional additional penalty given if packet is failed and/or possibly PDB violation is noticed. If gNB is capable estimating packet error probability p, it can be also taken into account by scaling k. Packet error probability can be estimated from MCS used for received transmission and SINR measured at the time of reception on used RBs. In this study Fₑᵣᵣₒᵣ was −10 if PDCP packet was not received correctly. Alternatively, e.g. Fₑᵣᵣₒᵣ=PDB−delay could be used as penalty if packet is received after PDB has expired.

An alternative definition of the reward might be as follows:

$$r = \frac{{σ}_{i}}{2 {\sum }_{j = 1}^{J} {K}_{j}} + {ε}_{i} + {φ}_{i}$$

where J is the total number of lower layer transmissions (i.e. segments and their retransmissions) of the i-th PDCP PDU. Additional packet delay budget (PDB) violation penalties ε and φ are given by:

$${ε}_{i} = 10 ( {T}_{max} - {τ}_{i} ) , if {τ}_{i} > {T}_{max}$$

$${ε}_{i} = 0 , if {τ}_{i} \leq {T}_{max}$$

and

<φᵢ=0,if reception is successful

<φᵢ=−10,if reception failed

where T is the time from expected packet arrival to successful reception or failure in milliseconds and Tₘₐₓ denotes maximum PDB.

Simulation parameterization followed following 3GPP assumptions for XR uplink traffic.

We utilized 20 MHz FR1 TDD carrier in urban macro scenario. Uplink traffic model was 100 B packets with 4 ms inter-arrival time. Packet delay budget for such traffic was determined to be 10 ms. In the plots 170 and 180, example delay distribution results are provided with 84 UEs within simulation area. The same parametrizations were used for all seven random simulation drops in dense macro cell environment. As can be seen traditional OLLA-based link adaptation reaches its best performance with the BLER target of 10-20%. It can be seen that ML-based approach can better avoid situations where there is more than one packet in the transmission buffer at a time. Hence, it can provide clearly better performance especially for high reliability targets.

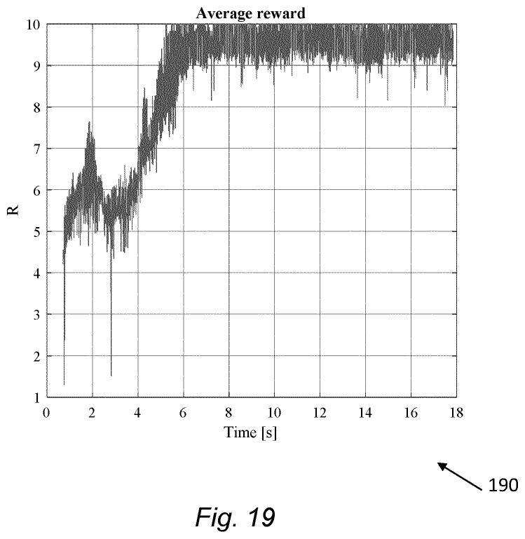

In FIG. 19, it is shown how the proposed ML algorithm converges. In particular, we did ˜7 second exploration period for each UE's link adaptation. Most probably a shorter time would suffice as well, and it has to be remembered that OLLA needs some time to converge as well. Due to simulation practicalities we did the exploration for all UEs at the same time and we do not have pre-stored information available for ML. Hence, we are starting simulation runs always from a scratch. In real environment however, offset for a single UE can be explored most probably more quickly, because all UEs are not exploring at the same time and stored—already learned—values can be reused as a starting point. For example, gNB may have already converged learned values for certain SINR regions. Hence, when UE connects, pre-initialized values (e.g. Q-table in Q-learning) matching first SINR measurements (or CQIs in DL) can be used as a starting point for ML.

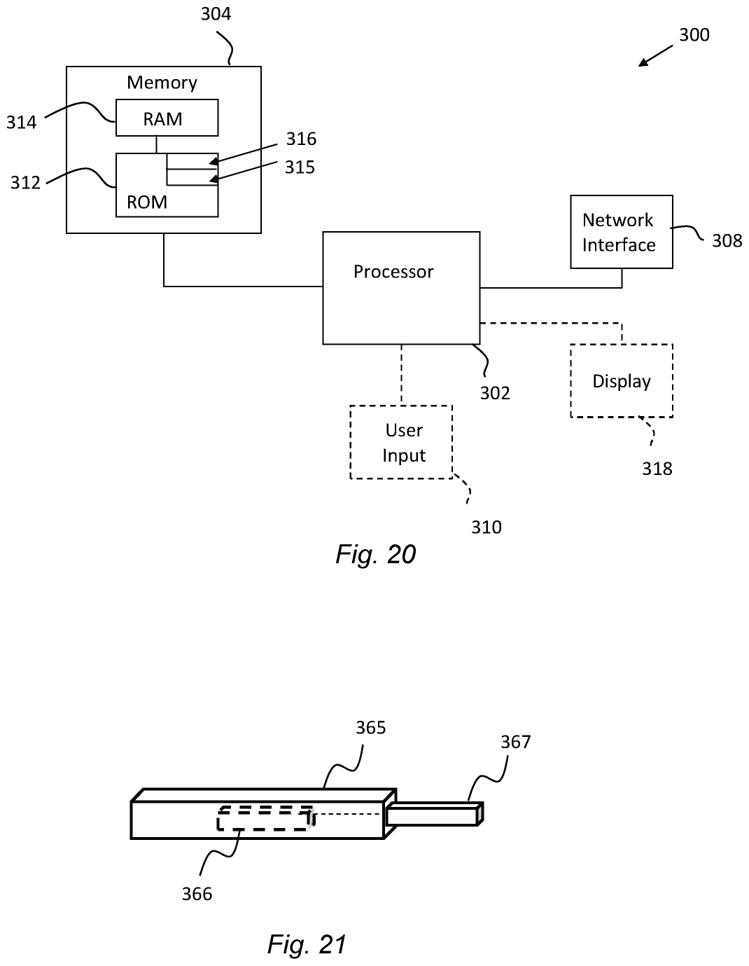

For completeness, FIG. 20 is a schematic diagram of components of one or more of the example embodiments described previously, which hereafter are referred to generically as a processing system 300. The processing system 300 may, for example, be (or may include) the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms and signalling diagrams 50, 70, 80, 130, 150 and 160 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 21 shows tangible media, specifically a removable memory unit 365, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and signalling diagrams of FIGS. 5, 7, 8, 13, 15 and 16 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus, comprising:
at least one processor; and
at least one non-transitory memory storing instructions that, when executed with the at least one processor, cause the apparatus to perform:
generating a channel quality metric offset;
summing a channel quality metric and the channel quality metric offset to generate an adjusted channel quality metric of a channel of a mobile communication system;
setting a modulation and coding scheme for transmitting data over the channel based, at least in part, on the adjusted channel quality metric;
obtaining feedback data relating to the success of data transfer over said channel;
compiling a loss/reward function based, at least in part, on said feedback data; and
updating a model using the loss/reward function, wherein the model is used in the generation of said channel quality metric offset.

2. An apparatus as claimed in claim 1, wherein:
the channel quality metric offset is based, at least in part, on a target error rate for transmissions using the mobile communication system.

3. An apparatus as claimed in claim 1, wherein the feedback data includes an acknowledgment signal indicative of whether a previous transmission over the channel was successful.

4. An apparatus as claimed in claim 1, wherein the instructions, when executed with the at least one processor, cause the apparatus to perform:
generating the loss/reward function based on a predicted error rate and the obtained feedback signal.

5. An apparatus as claimed in claim 1, wherein the instructions, when executed with the at least one processor, cause the apparatus to perform:
obtaining an initial offset value and an average offset step size from the model; and
increasing or decreasing the channel quality metric offset, depending on the feedback signal, an amount dependent, at least in part, on the average offset step size.

6. An apparatus as claimed in am claim 1, wherein the instructions, when executed with the at least one processor, cause the apparatus to perform:
generating or updating a computational graph comprising the channel quality metric, the channel quality metric offset, the modulation and coding scheme, and the feedback signal, wherein the model is based on said computational graph.

7. An apparatus as claimed in a claim 1, wherein the instructions, when executed with the at least one processor, cause the apparatus to perform:
generating, in response to a change in the channel quality metric, a channel quality metric correction term for smoothing adjustments to the channel quality metric offset when summing the channel quality metric and the channel quality metric offset.

8. An apparatus as claimed in claim 1, wherein the model provides said channel quality metric offset.

9. An apparatus as claimed in claim 8, wherein the feedback signal includes an indication of whether a transmission of a packet of data was successful.

10. An apparatus as claimed in claim 8, wherein the instructions, when executed with the at least one processor, cause the apparatus to perform:
obtaining accumulated physical resource block usage in an attempted delivery of the packet of data; and
generating the loss/reward function based, at least in part, on the accumulated physical resource block usage and the indication of whether the delivery of the packet was successful.

11. An apparatus as claimed in claim 8, wherein the packet of data comprises a packet data convergence protocol packet.

12. An apparatus as claimed in claim 8, wherein the loss/reward function is based, at least in part, on at least one of failed packet indications packet delay budget violations.

13. An apparatus as claimed in claim 1, wherein the channel quality metric comprises a signal-to-noise-plus-interference ratio signal.

14. An apparatus as claimed in claim 1, wherein the instructions, when executed with the at least one processor, cause the apparatus to perform:
selecting said modulation and coding scheme based on the adjusted channel quality metric and the target error rate using an inner loop link adaptation algorithm.

15. An apparatus as claimed in claim 1, wherein said channel quality metric offset is a user device-specific offset.

16. An apparatus as claimed in claim 1, wherein the instructions, when executed with the at least one processor, cause the apparatus to perform:
determining whether to trigger training of the model.

17. An apparatus as claimed in claim 1, wherein the instructions, when executed with the at least one processor, cause the apparatus to perform:
resetting the model on detection of a reset condition.

18. A method comprising:
generating a channel quality metric offset;
summing a channel quality metric and the channel quality metric offset to generate an adjusted channel quality metric of a channel of a mobile communication system;
setting a modulation and coding scheme for transmitting data over the channel based, at least in part, on the adjusted channel quality metric;
obtaining feedback data relating to the success of data transfer over said channel;
compiling a loss/reward function based, at least in part, on said feedback data; and
updating a model using the loss/reward function, wherein the model is used in the generation of said channel quality metric offset.

19. A non-transitory program storage device readable with an apparatus, tangibly embodying a program of instructions executable with the apparatus to perform at least the following:
generating a channel quality metric offset;
summing a channel quality metric and the channel quality metric offset to generate an adjusted channel quality metric of a channel of a mobile communication system;
setting a modulation and coding scheme for transmitting data over the channel based, at least in part, on the adjusted channel quality metric;
obtaining feedback data relating to the success of data transfer over said channel;
compiling a loss/reward function based, at least in part, on said feedback data; and
updating a model using the loss/reward function, wherein the model is used in the generation of said channel quality metric offset.
